(19) United States
(12) Patent Application Publication
(10) Pub. No.: US 2026/0296424 A1
(43) Pub. Date: Oct. 1, 2026

(54) System for Limiting a Speed of a Vehicle and Method for Overruling a Speed Limitation of a Vehicle

(71) Applicant: BAYERISCHE MOTOREN WERKE AKTIENGESELLSCHAFT, München (DE)

(72) Inventors: Helena DOLINAJ, Muenchen (DE); Christian SCHWALBACH, Muenchen (DE)

(21) Appl. No.: 19/478,379

(22) PCT Filed: Feb. 9, 2024
(86) PCT No.: PCT/EP2024/053387

§ 371 Date: Oct. 24, 2025

(30) Foreign Application Priority Data
Apr. 26, 2023 (DE) 10 2023 110 640.6

(51) Int. Cl. B60W 30/14; B60W 50/12

(52) U.S. Cl. CPC B60W 30/146; B60W 50/12; B60W 2540/10

(57) ABSTRACT

The invention relates to a system for limiting a speed of a vehicle designed to limit an effect of an actuation of an accelerator pedal of the vehicle in such a way that the vehicle does not exceed a limit speed set by a driver or determined from map information and/or surroundings sensor information, wherein the speed of the vehicle is situationally additionally limited to a cornering limit speed derived from map information, which is lower than the limit speed. The limitation to the cornering limit speed and the limitation to the limit speed can be overruled by actuating the accelerator pedal beyond a first actuating threshold. Furthermore, the limitation to the cornering limit speed, but not the limitation to the limit speed, can be overruled by actuating the accelerator pedal beyond a second actuating threshold which differs from the first actuating threshold.

### BACKGROUND AND SUMMARY

The invention relates to a system for limiting a speed of a vehicle and to a method for overriding a speed limitation of a vehicle. Furthermore, the invention relates to a computer program for carrying out such a method and to a computer-readable storage medium, on which such a computer program is stored.

In road traffic, an unadapted speed is a frequent cause of accidents. Speed restrictions are intended to keep the traffic in a speed range adapted to the respective road type or condition. A driver assistance system which is present in many modern motor vehicles and is usually referred to as a speed limiter or a speed limit device (SLD) assists the driver in not exceeding a self-selected speed limit and therefore contributes to increased traffic safety. In a similar manner to that in conventional speed control, the speed limiter function intervenes in the engine and transmission control in order to reduce the engine torque required by the driver before the selected limit speed is exceeded. There is always the possibility of the driver deliberately exceeding the set limit by completely or almost completely pressing down the accelerator pedal, for example. The limitation is then canceled and the system is in so-called override. Consequently, it is then also possible to drive above the limit speed as usual; the driver also need not permanently maintain the large accelerator pedal angle for this purpose.

In addition to an ability to manually set a limit speed, in advanced systems it is also possible to automatically take over a speed restriction applicable in a road section currently being used from digital map information and/or on the basis of camera-based road sign recognition.

In addition, map-based consideration of a route course may be provided such that the speed, for example on bends, is limited to a bend limit speed that is appropriate for a radius of curvature of the bend and may be lower than the limit speed set. Here, it may be the case that the bend limit speed derived from the map information does not match the actual situation, that is to say the real course of the road, for example on account of a limited mapping quality or obsolete map data. For example, the speed on an actually gentle bend may be limited to an unnecessarily low bend limit speed on account of a map error. In such a situation, the driver normally needs to override the speed limiter. However, with a conventional override scheme, which requires very extensive pressing of the accelerator pedal (for example to a kick-down threshold or above), the overriding immediately results in sharp acceleration which can likewise be perceived by the driver as uncomfortable and inappropriate for cornering.

On the basis of this, an object of the present invention is to specify a system and a method for limiting a speed of a vehicle and for overriding a speed limitation, which overcome the above-mentioned disadvantages of solutions known in the prior art.

The object is achieved by the subjects of the independent patent claims. Advantageous embodiments are specified in the dependent patent claims.

A first aspect of the invention relates to a system for limiting a speed of a vehicle.

The vehicle may be, in particular, a motor vehicle. The term motor vehicle is intended to be understood as meaning, in particular, a land vehicle that is moved by machine power without being tied to tracks. A motor vehicle in this sense may be, for example, in the form of an automobile, a motorcycle or a tractor.

The system is configured to limit an effect of actuation of an accelerator pedal of the vehicle such that the vehicle does not exceed a limit speed set by a driver of the vehicle or (automatically) determined from map and/or environmental sensor information.

An accelerator pedal should be understood as meaning a pedal that can be used to set a drive power of the vehicle, that is to say, for example, a gas pedal in a vehicle with an internal combustion engine or a current pedal in an electrically driven vehicle.

If the limit speed is determined from map and/or environmental sensor information, it may be, in particular, a maximum permissible speed which applies to a route section used by the vehicle at present or in the near future and was taken from a digital map or was recognized by means of camera-based traffic sign recognition.

The system is also configured to situationally additionally (that is to say beyond the limitation to the limit speed) limit the speed of the vehicle to a bend limit speed which is derived from map information and is lower than the limit speed. In this case, the bend limit speed can be determined, for example, on the basis of a bend curvature determined from a digital map and/or on the basis of a bend radius determined from a digital map. Generally, a route course is taken into account when determining the bend limit speed.

The limitation of the speed of the vehicle to the bend limit speed and the limitation of the speed of the vehicle to the limit speed can be overridden by actuating the accelerator pedal beyond a first actuation threshold. In other words, a first actuation threshold is provided and, when exceeded, both limitations-that is to say both the limitation to the bend limit speed and the limitation to the limit speed-are overridden. For example, the first actuation threshold may be selected such that the accelerator pedal must be depressed to a kick-down threshold or even beyond this in order to override, in particular, the limitation to the limit speed. Embodiments in which the first actuation threshold is set for an accelerator pedal angle of more than 90%, for example 96%, of a full deflection are conceivable, for example.

According to forms of the invention, a second actuation threshold different from the first actuation threshold is now additionally provided, wherein the limitation of the speed of the vehicle to the bend limit speed, but not limitation of the speed of the vehicle to the limit speed, can be overridden by actuating the accelerator pedal beyond the second actuation threshold. That is to say, when the second actuation threshold is exceeded, only the limitation to the bend limit speed is canceled, whereas the limitation to the limit speed (higher in comparison with the bend limit speed) can remain active.

In particular, the first actuation threshold and the second actuation threshold can be set in such a manner that less intensive accelerator pedal actuation suffices to override the limitation to the bend limit speed in comparison with accelerator pedal actuation that is needed to override the limitation to the limit speed. The second actuation threshold may therefore be set to be more sensitive than the first actuation threshold or the system can be more sensitive to accelerator pedal actuation for overriding the limitation to the bend limit speed than to accelerator pedal actuation for overriding the limitation to the limit speed by setting the first and second actuation thresholds. For example, the overriding of the limitation to the bend limit speed when pressing the accelerator pedal may take effect sooner than the overriding of the limitation to the (higher) limit speed.

In this case, the invention is based on the concept that it is useful to provide a second actuation threshold, by means of which the limitation to the bend limit speed can be overridden more easily than the limitation to the limit speed, since the limitation to the bend limit speed is only an automatic comfort function for driving through particular route events, but not a speed limit that is legally valid or imposed by the driver himself. At the same time, a second actuation threshold that is more sensitive than the first actuation threshold solves the problem described at the outset of excessively drastic acceleration when overriding the speed limiter function on a bend, on which the speed is limited to a bend limit speed that is perceived to be excessively low.

According to one embodiment, the first actuation threshold and/or the second actuation threshold can each correspond to a particular accelerator pedal angle. For example, the first actuation threshold may correspond to an accelerator pedal angle that is greater than or equal to 80%, in particular greater than or equal to 90%, of a full deflection (that is to say of an accelerator pedal angle when completely pressed) of the accelerator pedal. It is also conceivable for the first actuation threshold to correspond to an accelerator pedal angle of 95% or more, for example 96%, of a full deflection of the accelerator pedal. In this case, the second actuation threshold may correspond to a smaller accelerator pedal angle, for example in the range of 60% to 80%, in particular in the range of 65% to 75%, of a full deflection.

It is also within the scope of the invention that the first actuation threshold and/or the second actuation threshold can each correspond to a particular temporal change in an accelerator pedal angle. In other words, the first actuation threshold and/or the second actuation threshold may be defined by a temporal gradient (that is to say a derivative with respect to time) of the accelerator pedal actuation. It is conceivable, for example, for the second actuation threshold to be reached when a temporal change in the accelerator pedal angle is 500%/s, wherein the stated percentage relates to a full deflection (that is to say the entire angular range that can be assumed by the accelerator pedal position). In other words, if an accelerator pedal angle change is determined, which takes place so quickly that, with this accelerator pedal angle rate of change if (theoretically) continued for one second, an angle corresponding to at least five times the entire angular range in which the accelerator pedal can be set would be exceeded, the second actuation threshold would be reached or exceeded in this exemplary embodiment.

According to some embodiments, mixed forms are also possible such that, for example, the first actuation threshold is defined by a particular accelerator pedal angle and the second actuation threshold is defined by a particular temporal change in an accelerator pedal angle (or vice versa).

A second aspect of the invention is a vehicle, in particular a motor vehicle, having a system according to the first aspect of the invention.

A third aspect of the invention is a computer-implemented method for overriding a speed limitation of a vehicle, having the steps of: determining a limit speed from a specification by a driver of the vehicle or on the basis of map and/or environmental sensor information; generating control signals for limiting an effect of actuation of an accelerator pedal of the vehicle, such that the vehicle does not exceed the limit speed; determining a bend limit speed for a bend currently being driven through by the vehicle or an upcoming bend from map information, wherein the bend limit speed is lower than the limit speed; generating control signals for limiting the speed of the vehicle, beyond the limitation to the limit speed, to the bend limit speed (in particular if the vehicle is on the bend or is just before the bend); generating control signals for canceling the limitation to the bend limit speed and the limitation to the limit speed if the accelerator pedal is actuated beyond a first actuation threshold; and canceling the limitation to the bend limit speed, but not the limitation to the limit speed, if the accelerator pedal is actuated beyond a second actuation threshold different from the first actuation threshold.

The method according to the third aspect of the invention can be carried out by means of a system according to the first aspect of the invention. Accordingly, the explanations above and below of the system according to the invention and its possible configurations may be similarly understood for the method according to the invention and vice versa.

The system according to the invention may comprise, for example, a (data) processing device which has at least one processor and is configured to carry out the method according to the third aspect of the invention by means of the at least one processor. According to some embodiments, it may also be a spatially distributed (for example over a plurality of processors or microcontrollers spaced apart from one another) processing device.

For example, the processing device may be a control unit or part of a control unit of the vehicle. In particular, it may be a control unit for controlling a speed limiter function.

A fourth aspect of the invention is a computer program comprising instructions which, when the computer program is executed by a processing device (for example a processing device of a system according to the first aspect of the invention), cause the latter to carry out a method according to the third aspect of the invention. In this case, the computer program may be divided into a plurality of separate subprograms which can each be executed by different, possibly spatially remote, processing devices (for example a plurality of separate processors).

A processing device of a system according to the first aspect of the invention may be configured (in particular programmed) to execute a computer program according to the fourth aspect of the invention.

A fifth aspect of the invention is a computer-readable storage medium comprising instructions which, when executed by a (possibly distributed) processing device, cause the latter to carry out a method according to the third aspect of the invention. In other words, a computer program according to the fourth aspect of the invention may thus be stored on the computer-readable storage medium.

The invention is now explained in more detail on the basis of exemplary embodiments and with reference to the accompanying drawings.

### BRIEF DESCRIPTION OF THE DRAWINGS

FIG. 1 illustrates, by way of example and schematically, a system for limiting a speed of a vehicle.

FIG. 2 illustrates, by way of example and schematically, steps of a method for overriding a speed limitation of a vehicle.

### DETAILED DESCRIPTION OF THE DRAWINGS

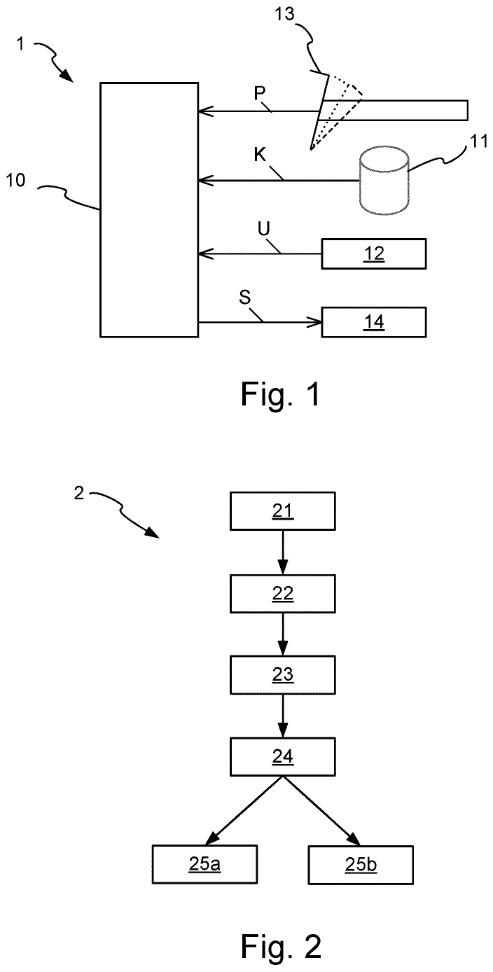

A system 1 for limiting a speed of a vehicle, as schematically illustrated in FIG. 1, is explained below with reference to steps 21 to 25a,b of a method 2 for overriding a speed limitation which are illustrated FIG. 2 in the form of a block diagram.

The system 1 comprises an accelerator pedal 13 and a processing device 10 which is connected to the accelerator pedal 13 using signaling and is configured to receive a pedal signal P from the accelerator pedal 13 or from an accelerator pedal angle sensor arranged thereon. The pedal signal P may contain, for example, information relating to an accelerator pedal angle that has been set.

The processing device 10 is also connected to a drive module 14 using signaling. In this case, the processing device 10 is configured to determine a control signal S on the basis of the received pedal signal P and to output the control signal S to the drive module 14. The drive module 14 can then provide a drive torque for the vehicle on the basis of the control signal S.

In particular, the processing device 10 is configured to generate the control signals S on the basis of the pedal signals P in such a manner that an effect of actuation of the accelerator pedal 13 by a driver of the vehicle is limited such that the vehicle does not exceed a limit speed that can be set by the driver. In other words, if the vehicle is already traveling at the limit speed, the processing device 10 ignores further actuation of the accelerator pedal 13, such that no control signal S for further accelerating the vehicle is output to the drive module 14.

The limit speed cannot only be set by the driver, but may additionally or alternatively be determined from map and/or environmental sensor information. For example, the system 1 may comprise a map memory 11 that is connected to the processing device 10 using signaling. The processing device 10 can retrieve map information K from the map memory, which map information comprises information relating to a prescribed speed limit that applies in a route section that is used by the vehicle at present or (for example according to route planning) in the near future. The speed limit may then be directly adopted as the limit speed, for example. However, it is also conceivable for the speed limit to be modified by a certain offset, such that a speed value corresponding to the speed limit plus or minus the offset is adopted as limit speed within the scope of the speed limiter function.

As an alternative or in addition to the map information K, environmental sensor information may also be used as the basis for determining the limit speed. For example, the system may comprise an environmental sensor system 12 that provides the processing device 10 with environmental sensor information U. In this case, the environmental sensor information U may comprise, for example, camera images, from which the processing device 10 can determine the speed limit applicable to the route section currently being used or the route section ahead by means of automatic traffic sign recognition. A speed limit determined in this manner can also be set—if appropriate when modified by an offset—as the limit speed.

The processing device 10 is also configured to generate the control signals S for the drive module 14 on the basis of the pedal signals P received from the accelerator pedal 13 in such a manner that the speed of the vehicle is limited in certain situations, specifically in particular during or before cornering, in addition to the limitation to the limit speed, to a bend limit speed which is derived from map information K and is lower than the limit speed. In this case, the map information K used to determine the bend limit speed need not necessarily be the same map information K from which the limit speed is derived. Rather, separate digital maps can be used as sources for both purposes. In this case, the bend limit speed may be effected, in particular, on the basis of a bend curvature determined from a digital map and/or on the basis of a bend radius determined from a digital map. In other words, a bend limit speed that enables cornering which is comfortable for the vehicle occupant(s) can be determined on the basis of a bend radius or a bend curvature. This bend limit speed may be lower in certain situations than the limit speed which may correspond, for example, to an official speed limit applicable to the respective route section.

The speed limitation by the system 1 can be overridden by the driver in such a manner that both the limitation to the (lower) bend limit speed and the limitation to the (higher) limit speed are canceled if the driver presses the accelerator pedal 13 beyond a first actuation threshold. In the schematic illustration according to FIG. 1, this first actuation threshold is illustrated by the position of the accelerator pedal 13 depicted by dashed lines.

In addition, a pedal position which is illustrated in FIG. 1 using dotted lines and corresponds to a second actuation threshold is provided. If this second actuation threshold is exceeded, the limitation of the speed of the vehicle to the bend limit speed, but not the limitation to the limit speed, is canceled (that is to say overridden). In the exemplary embodiment shown, the second actuation threshold corresponds to an accelerator pedal angle that is established when the accelerator pedal 13 is pressed to a lesser extent in comparison with the accelerator pedal actuation that is needed to reach the first actuation threshold.

For example, the first actuation threshold and the second actuation threshold may be selected in such a manner that the first actuation threshold is reached when the accelerator pedal angle is 96% of a maximum accelerator pedal angle (which is present when the accelerator pedal is completely pressed). In contrast, the second actuation threshold is already reached at a considerably smaller accelerator pedal angle, for example 70% of the maximum accelerator pedal angle. The first actuation threshold and the second actuation threshold are therefore set in such a manner that less intensive accelerator pedal actuation suffices to override the limitation to the bend limit speed in comparison with accelerator pedal actuation that is needed to (also) override the limitation to the limit speed.

In an example scenario, the vehicle initially drives on a straight route at a set limit speed of 100 km/h. This limit speed can correspond, for example, to the official speed limitation applicable in the relevant route section. If the vehicle now drives toward a bend, the limit speed does not change. However, on the basis of the route course information contained in map data, in particular on the basis of bend radii contained in the map information, it can be deduced that driving through the upcoming bend at a maximum of 50 km/h would be comfortable. The speed limiter function implemented by the system 1 consequently limits the speed of the vehicle during (and possibly even shortly before) cornering to the bend limit speed of 50 km/h. However, the driver may perceive this bend limit speed to be too slow in some situations, for instance in situations in which the bend limit speed has been set too low on account of incorrect map information K. The driver therefore increases the accelerator pedal angle beyond the second actuation threshold, such that he can accelerate the vehicle again to the set limit speed of 100 km/h. If the driver would like to accelerate even beyond the limit speed of 100 km/h, he can press the accelerator pedal 13 even further and, when the first actuation threshold is exceeded, can override the limitation to the limit speed. As a result of the fact that, in addition to the first actuation threshold, the second actuation threshold that is “softer” in comparison is provided, the driver is not forced on the bend to accept a drastic acceleration that would be established if he had to immediately exceed the first actuation threshold in order to override the limitation to the bend limit speed. As a result, the system 1 may thus contribute to increasing the driver comfort when using a speed limiter function that takes into account a route course.

In accordance with the statements above, the system 1 is configured to carry out method steps 21 to 25a,b according to FIG. 2 which are described below by means of the processing device 10.

In a method step 21, the processing device 10 determines a limit speed from a specification by a driver of the vehicle or on the basis of map information K and/or environmental sensor information U.

In a method step 22, the processing device generates control signals for limiting an effect of actuation of the accelerator pedal 13, such that the vehicle does not exceed the limit speed.

In a method step 23, the processing device 10 determines a bend limit speed from map information K, wherein the bend limit speed is lower than the limit speed.

In a method step 24, the processing device generates control signals for limiting the speed of the vehicle, beyond the limitation to the limit speed, to the (lower) bend limit speed.

If the accelerator pedal 13 is actuated beyond the first actuation threshold (cf. the pedal position depicted using dashed lines in FIG. 1), the processing device 10 generates in a method step 25a control signals for canceling both the limitation to the bend limit speed and the limitation to the limit speed. Consequently, the vehicle can be accelerated by actuating the accelerator pedal 13 beyond the limit speed.

If, in contrast, the accelerator pedal 13 is actuated beyond the second actuation threshold (cf. the pedal position illustrated using dotted lines in FIG. 1), but not beyond the first actuation threshold, the processing device 10 generates in a method step 25b control signals for canceling the limitation of the speed of the vehicle to the bend limit speed, but not the limitation to the limit speed. Consequently, the vehicle can therefore be accelerated by actuating the accelerator pedal 13 beyond the bend limit speed, but not beyond the limit speed (until the first actuation threshold is exceeded).

1.-9. (canceled)

10. A system for limiting a speed of a vehicle, comprising:
one or more processors configured to limit an effect of actuation of an accelerator pedal of the vehicle such that the vehicle does not exceed a limit speed set by a driver or determined from at least one of map information or environmental sensor information;
wherein the speed of the vehicle is situationally additionally limited to a bend limit speed which is derived from map information and is lower than the limit speed;
wherein the limitation to the bend limit speed and the limitation to the limit speed can be overridden by actuating the accelerator pedal beyond a first actuation threshold; and
wherein the limitation to the bend limit speed, but not the limitation to the limit speed, can be overridden by actuating the accelerator pedal beyond a second actuation threshold different from the first actuation threshold.

11. The system according to claim 10, wherein the first actuation threshold and the second actuation threshold are set in such a manner that less intensive accelerator pedal actuation suffices to override the limitation to the bend limit speed in comparison with accelerator pedal actuation that is needed to override the limitation to the limit speed.

12. The system according to claim 10, wherein at least one of the first actuation threshold or the second actuation threshold correspond(s) to an accelerator pedal angle.

13. The system according to claim 10, wherein at least one of the first actuation threshold or the second actuation threshold correspond(s) to a temporal change in an accelerator pedal angle.

14. A vehicle comprising a system according to claim 10.

15. A computer-implemented method for overriding a speed limitation of a vehicle, the method comprising the steps of:
determining a limit speed from a specification by a driver of the vehicle or on the basis of at least one of map information or environmental sensor information;
generating control signals for limiting an effect of actuation of an accelerator pedal of the vehicle, such that the vehicle does not exceed the limit speed;
determining a bend limit speed from map information, wherein the bend limit speed is lower than the limit speed;
generating control signals for limiting the speed of the vehicle, beyond the limitation to the limit speed, to the bend limit speed;
generating control signals for canceling the limitation to the bend limit speed and the limitation to the limit speed when the accelerator pedal is actuated beyond a first actuation threshold; and
generating control signals for canceling the limitation to the bend limit speed, but not the limitation to the limit speed, when the accelerator pedal is actuated beyond a second actuation threshold different from the first actuation threshold.

16. The method according to claim 15, wherein a bend limit speed is determined on the basis of a bend curvature determined from at least one of a digital map or on the basis of a bend radius determined from a digital map.

17. A computer-readable storage medium comprising a set of instructions which, when executed by a processing device cause the processing device to execute the method of claim 15.

18. A system for overriding a speed limitation of a vehicle, the system comprising one or more processors configured to:
determine a limit speed from a specification by a driver of the vehicle or on the basis of at least one of map information or environmental sensor information;
generate control signals for limiting an effect of actuation of an accelerator pedal of the vehicle, such that the vehicle does not exceed the limit speed;
determine a bend limit speed from map information, wherein the bend limit speed is lower than the limit speed;
generate control signals for limiting the speed of the vehicle, beyond the limitation to the limit speed, to the bend limit speed;
generate control signals for canceling the limitation to the bend limit speed and the limitation to the limit speed when the accelerator pedal is actuated beyond a first actuation threshold; and
generate control signals for canceling the limitation to the bend limit speed, but not the limitation to the limit speed, when the accelerator pedal is actuated beyond a second actuation threshold different from the first actuation threshold.
